(19) United States
(12) Patent Application Publication
(10) Pub. No.: US 2026/0056669 A1
(43) Pub. Date: Feb. 26, 2026

(54) SELECTABLE ERROR HANDLING MODES IN MEMORY SYSTEMS

(71) Applicant: Micron Technology, Inc., Boise, ID (US)

(72) Inventors: Yong Hua Pan, Shanghai (CN); Vitaly Kolonov, Santa Clara, CA (US); Robert Fallone, Ladera Ranch, CA (US); Jianping Tian, Shanghai (CN)

(21) Appl. No.: 19/103,773

(22) PCT Filed: Aug. 16, 2022
(86) PCT No.: PCT/CN2022/112747

§ 371 Date: Feb. 13, 2025

(51) Int. Cl. G06F 3/06

(52) U.S. Cl. CPC G06F 3/0619; G06F 3/0611; G06F 3/0655; G06F 3/0679

(57) ABSTRACT

Aspects of the present disclosure configure a system component, such as memory sub-system controller, to capture debugging information in memory sub-system operations in response to a critical event. The memory sub-system controller receives critical event trigger data and determines whether the critical event trigger data corresponds to a fatal condition. The memory sub-system controller selects an error handling mode from a plurality of error handling modes based on determining whether the critical event trigger data corresponds to the fatal condition. A first of the plurality of error handling modes corresponds to storing a first set of debugging information associated with a memory sub-system. A second of the plurality of error handling modes corresponds to storing a second set of debugging information associated with the memory sub-system without interrupting a host. The second set can be a subset of the first set of debugging information.

### TECHNICAL FIELD

Embodiments of the disclosure relate generally to memory sub-systems and more specifically, to debugging a memory sub-system.

### BACKGROUND

A memory sub-system can be a storage system, such as a solid-state drive (SSD), and can include one or more memory components that store data. The memory components can be, for example, non-volatile memory components and volatile memory components. In general, a host system can utilize a memory sub-system to store data at the memory components and to retrieve data from the memory components.

### BRIEF DESCRIPTION OF THE DRAWINGS

The present disclosure will be understood more fully from the detailed description given below and from the accompanying drawings of various embodiments of the disclosure.

FIG. 1 is a block diagram illustrating an example computing environment including a memory sub-system, in accordance with some embodiments of the present disclosure.

FIG. 2 is a block diagram of an example error handling module, in accordance with some implementations of the present disclosure.

FIGS. 3-5 are flow diagrams of example methods to perform memory sub-system debugging operations, in accordance with some implementations of the present disclosure.

FIG. 6 is a block diagram illustrating a diagrammatic representation of a machine in the form of a computer system within which a set of instructions can be executed for causing the machine to perform any one or more of the methodologies discussed herein, in accordance with some embodiments of the present disclosure.

### DETAILED DESCRIPTION

Aspects of the present disclosure configure a system component, such as a memory sub-system controller, to debug or initiate debugging operations for a memory sub-system. The memory sub-system controller can selectively perform different types of error handling modes in response to receiving critical event trigger data. The memory sub-system controller can perform debugging operations according to a first error handling mode when the critical event trigger data corresponds to a fatal condition and can debugging operations according to a second error handling mode when the critical event trigger data corresponds to a non-fatal condition. The determination of whether the critical event trigger data corresponds to a fatal or non-fatal condition can be based on a type or error or error code that is received or detected by the firmware of the memory sub-system controller. In some examples, the debugging operations according to the second error handling mode can be performed without interrupting a host while debugging operations according to the first error handling mode can cause a host to be interrupted. Depending on which type of debugging operations are being performed, different sets of debugging information can be collected and stored. The set of debugging information can include a full snapshot which captures all internal driver data or partial snapshot in which only some portion of data from certain internal memory drivers is captured. In this way, the memory sub-system controller can continue operating the memory sub-system without interrupting the host on the basis of the type of errors that are detected which improves the overall efficiency of operating the memory sub-system.

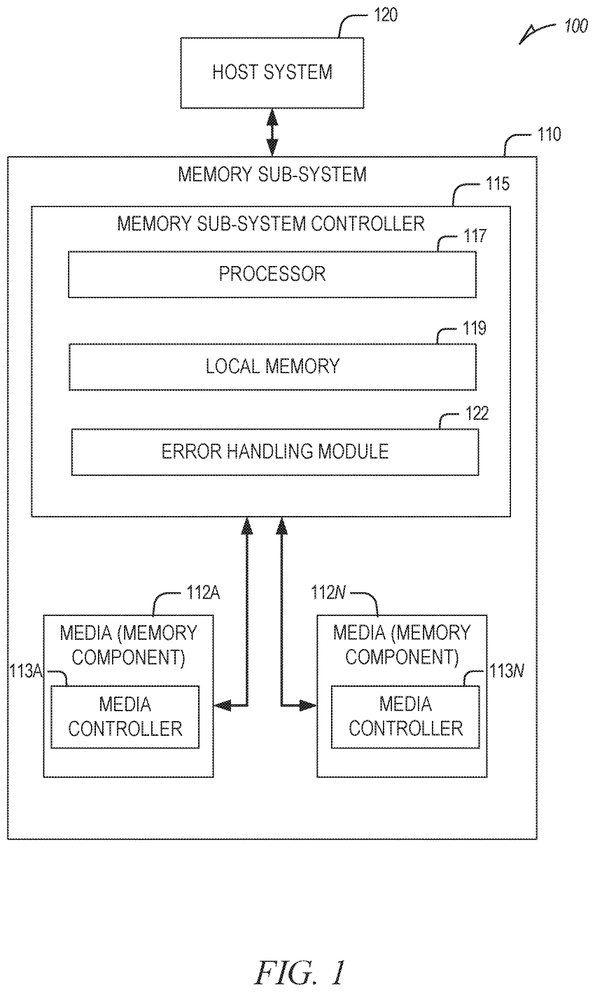

A memory sub-system can be a storage device, a memory module, or a hybrid of a storage device and memory module. Examples of storage devices and memory modules are described below in conjunction with FIG. 1. In general, a host system can utilize a memory sub-system that includes one or more memory components, such as memory devices that store data. The host system can send access requests (e.g., write command, read command, sequential write command, sequential read command) to the memory sub-system, such as to store data at the memory sub-system and to read data from the memory sub-system. The data specified by the host is hereinafter referred to as “host data” or “user data”.

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., ECC codeword, parity code), data version (e.g., used to distinguish age of data written), valid bitmap (which LBAs or logical transfer units contain valid data), etc.

The memory sub-system can initiate media management operations, such as a write operation, on host data that is stored on a memory device. For example, firmware of the memory sub-system may re-write previously written host data from a location on a memory device to a new location as part of garbage collection management operations. The data that is re-written, for example as initiated by the firmware, is hereinafter referred to as “garbage collection data”.

“User data” can include host data and garbage collection data. “System data” hereinafter refers to data that is created and/or maintained by the memory sub-system for performing operations in response to host requests and for media management. Examples of system data include, and are not limited to, system tables (e.g., logical-to-physical address mapping table), data from logging, scratch pad data, etc.

A memory device can be a non-volatile memory device. A non-volatile memory device is a package of one or more dice. Each die can comprise one or more planes. For some types of non-volatile memory devices (e.g., NAND devices), each plane comprises a set of physical blocks. For some memory devices, blocks are the smallest area than can be erased. Each block comprises a set of pages. Each page comprises a set of memory cells, which store bits of data. The memory devices can be raw memory devices (e.g., NAND), which are managed externally, for example, by an external controller. The memory devices can be managed memory devices (e.g., managed NAND), which is a raw memory device combined with a local embedded controller for memory management within the same memory device package. The memory device can be divided into one or more zones where each zone is associated with a different set of host data or user data or application.

Conventional memory sub-systems instruct the memory sub-system to obtain a snapshot in combination with various logs upon detecting occurrence of an issue or error. The type of snapshot that is captured is the same regardless of the type of error that is encountered and typically the host is always interrupted in case of encountering an error. For example, the memory sub-system controller can monitor progress of memory operations and once the controller detects an issue, the controller can instruct the memory sub-system to store its current state and inform the host. However, not all errors can be fatal and various input/output (I/O) operations can usually continue to be serviced and performed under certain error conditions. Interrupting a host and stopping memory sub-system operations upon encountering any error can therefore be wasteful and inefficient slowing down operations.

Aspects of the present disclosure address the above and other deficiencies by configuring a system component, such as a memory sub-system controller to selectively interrupt a host based on determining whether critical event trigger data corresponds to a fatal or non-fatal condition. Also, depending on whether the critical event trigger data corresponds to a fatal or non-fatal condition different types of snapshots and debugging operations can be performed to keep operating the memory sub-system in an efficient manner. The critical event trigger data can include at least one of Non-Volatile Memory Express (NVMe) command timeout being triggered, Cyclic Redundancy Code (CRC) Errors exceeding a CRC threshold, PCIe AXI Error event, Uncorrectable Errors (UE) event, read or write completion latency exceeding a read or write threshold, reset event information, or memory parity errors exceeding a parity threshold.

In some cases, to preserve storage space on the memory sub-system, the memory sub-system controller can selectively replace previously stored instances of debugging information (e.g., prior snapshots) when a new instance of debugging information (e.g., a new snapshot) is captured. Namely, the memory sub-system controller can access and evaluate certain conditions that represent how valuable the new snapshot is relative to the prior snapshots to decide whether to keep the new snapshot by replacing a prior snapshot or to discard the new snapshot entirely. The conditions can include a power cycle count, a power on time, or a count associated with input/output commands.

In some embodiments, the memory sub-system controller receives critical event trigger data and determines whether the critical event trigger data corresponds to a fatal condition. The memory sub-system controller selects an error handling mode from a plurality of error handling modes based on determining whether the critical event trigger data corresponds to the fatal condition. A first of the plurality of error handling modes can correspond to storing a first set of debugging information associated with the memory sub-system and a second of the plurality of error handling modes can correspond to storing a second set of debugging information associated with the memory sub-system without interrupting a host. The second set can be a subset of the first set of debugging information.

The first set of debugging information can include a state of the memory sub-system representing a status of at least one of one or more data structures, one or more queues, or one or more state machines. In some embodiments, the memory sub-system controller can select the first of the plurality of error handling modes in response to determining that the critical event trigger data corresponds to the fatal condition. In some embodiments, the memory sub-system controller transmits an interrupt signal to the host to initiate debugging operations in response to selecting the first of the plurality of error handling modes.

In some embodiments, the memory sub-system controller selects the second of the plurality of error handling modes in response to determining that the critical event trigger data corresponds to a non-fatal condition. In some embodiments, the memory sub-system controller generates the second set of debugging information according to a specified format and saves the second set of debugging information on the set of memory components.

In some embodiments, the memory sub-system controller initializes a timer for saving the second set of debugging information and determines that the timer has reached a threshold value. The memory sub-system controller determins whether the second set of debugging information has successfully been saved on the set of memory components in response to determining that the timer has reached the threshold value. In response to determining that the second set of debugging information has failed to successfully be saved on the set of memory components after the timer has reached the threshold value, the memory sub-system controller generates the first set of debugging information.

In some embodiments, the memory sub-system controller resets the memory sub-system and savs the first or second sets of debugging information on the set of memory components. In response to determining that the first of the plurality of error handling modes has been selected, the memory sub-system controller restricts a set of operations of the memory sub-system to operations performed in a basic function mode (BFM).

In some embodiments, the memory sub-system controller reserves a first portion of the set of memory components for storing one or more instances of the first set of debugging information and reserves a second portion of the set of memory components for storing one or more instances of the second set of debugging information. The memory sub-system controller stores one or more instances of sets of debugging information in a reserved portion of the set of memory components and receives a new instance of an individual set of debugging information corresponding to the selected error handling mode. In response, the memory sub-system controller replaces a target instance of the one or more instances stored in the reserved portion of the set of memory components with the new instance of the individual set of debugging information.

In some embodiments, the memory sub-system controller determines that a value associated with the target instance is lower than a value associated with the new instance. The target instance can be replaced in response to determining that the value associated with the target instance is lower than the value associated with the new instance. The memory sub-system controller determines that the value associated with the target instance is lower than the value associated with the new instance by determining whether one or more conditions for replacing the target instance are met. The one or more conditions include a power cycle count, a power on time, or a count associated with input/output commands. The target instance can be replaced in response to determining that a power cycle count, representing number of times the memory sub-system has been power cycled, transgresses a power cycle threshold value. The memory sub-system controller prevents replacing the target instance with the new instance in response to determining that a power cycle count, representing number of times the memory sub-system has been power cycled, fails to transgress a power cycle threshold value.

The target instance can be replaced in response to determining that the memory sub-system has been powered on for more than a threshold time period and an average quantity of input/output command completion rate transgresses a threshold rate. The memory sub-system controller prevents replacing the target instance with the new instance in response to determining that memory sub-system has been powered on for less than the threshold time period and the average quantity of input/output command completion rate fails to transgress the threshold rate. The target instance can be replaced in response to determining that the memory sub-system has been powered on for more than a threshold time period and a quantity of input/output commands that have been completed since the target instance was stored transgresses a threshold value. The memory sub-system controller prevents replacing the target instance with the new instance in response to determining that memory sub-system has been powered on for less than the threshold time period and the quantity of input/output commands that have been completed since the target instance was stored fails to transgress the threshold value.

Though various embodiments are described herein as being implemented with respect to a memory sub-system (e.g., a controller of the memory sub-system), some or all of the portions of an embodiment can be implemented with respect to a host system, such as a software application or an operating system of the host system.

FIG. 1 illustrates an example computing environment 100 including a memory sub-system 110, in accordance with some examples of the present disclosure. The memory sub-system 110 can include media, such as memory components 112A to 112N (also hereinafter referred to as “memory devices”). The memory components 112A to 112N can be volatile memory devices, non-volatile memory devices, or a combination of such. In some embodiments, the memory sub-system 110 is a storage system. A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and a non-volatile dual in-line memory module (NVDIMM).

The computing environment 100 can include a host system 120 that is coupled to a memory system. The memory system can include one or more memory sub-systems 110. In some embodiments, the host system 120 is coupled to different types of memory sub-system 110. FIG. 1 illustrates one example of a host system 120 coupled to one memory sub-system 110. The host system 120 uses the memory sub-system 110, for example, to write data to the memory sub-system 110 and read data from the memory sub-system 110. As used herein, “coupled to” generally refers to a connection between components, which can be an indirect communicative connection or direct communicative connection (e.g., without intervening components), whether wired or wireless, including connections such as electrical, optical, magnetic, etc.

The host system 120 can be a computing device such as a desktop computer, laptop computer, network server, mobile device, embedded computer (e.g., one included in a vehicle, industrial equipment, or a networked commercial device), or such computing device that includes a memory and a processing device. The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCle) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory components 112A to 112N when the memory sub-system 110 is coupled with the host system 120 by the PCIe interface. The physical host interface can provide an interface for passing control, address, data, and other signals (e.g., download and commit firmware commands/requests) between the memory sub-system 110 and the host system 120.

The memory components 112A to 112N can include any combination of the different types of non-volatile memory components and/or volatile memory components. An example of non-volatile memory components includes a negative-and (NAND)-type flash memory. Each of the memory components 112A to 112N can include one or more arrays of memory cells such as single-level cells (SLCs) or multi-level cells (MLCs) (e.g., TLCs or QLCs). In some embodiments, a particular memory component 112 can include both an SLC portion and an MLC portion of memory cells. Each of the memory cells can store one or more bits of data (e.g., blocks) used by the host system 120. Although non-volatile memory components such as NAND-type flash memory are described, the memory components 112A to 112N can be based on any other type of memory, such as a volatile memory.

In some embodiments, the memory components 112A to 112N can be, but are not limited to, random access memory (RAM), read-only memory (ROM), dynamic random access memory (DRAM), synchronous dynamic random access memory (SDRAM), phase change memory (PCM), magnetoresistive random access memory (MRAM), negative-or (NOR) flash memory, electrically erasable programmable read-only memory (EEPROM), and a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write-in-place operation, where a non-volatile memory cell can be programmed without the non-volatile memory cell being previously erased. Furthermore, the memory cells of the memory components 112A to 112N can be grouped as memory pages or blocks that can refer to a unit of the memory component 112 used to store data. In some examples, the memory cells of the memory components 112A to 112N can be grouped into a set of different zones of equal or unequal size used to store data for corresponding applications. In such cases, each application can store data in an associated zone of the set of different zones.

The memory sub-system controller 115 can communicate with the memory components 112A to 112N to perform operations such as reading data, writing data, or erasing data at the memory components 112A to 112N and other such operations. The memory sub-system controller 115 can include hardware such as one or more integrated circuits and/or discrete components, a buffer memory, or a combination thereof. The memory sub-system controller 115 can be a microcontroller, special-purpose logic circuitry (e.g., a field programmable gate array (FPGA), an application specific integrated circuit (ASIC), etc.), or another suitable processor. The memory sub-system controller 115 can include a processor (processing device) 117 configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120. In some embodiments, the local memory 119 can include memory registers storing memory pointers, fetched data, and so forth. The local memory 119 can also include read-only memory (ROM) for storing microcode. While the example memory sub-system 110 in FIG. 1 has been illustrated as including the memory sub-system controller 115, in another embodiment of the present disclosure, a memory sub-system 110 may not include a memory sub-system controller 115, and can instead rely upon external control (e.g., provided by an external host, or by a processor 117 or controller separate from the memory sub-system 110).

In general, the memory sub-system controller 115 can receive I/O commands or operations from the host system 120 and can convert the commands or operations into instructions or appropriate commands to achieve the desired access to the memory components 112A to 112N. The memory sub-system controller 115 can be responsible for other operations, based on instructions stored in firmware in an active slot or associated with an active firmware slot, such as wear leveling operations, garbage collection operations, error detection and ECC operations, decoding operations, encryption operations, caching operations, address translations between a logical block address and a physical block address that are associated with the memory components 112A to 112N, address translations between an application identifier received from the host system 120 and a corresponding zone of a set of zones of the memory components 112A to 112N. This can be used to restrict applications to reading and writing data only to/from a corresponding zone of the set of zones that is associated with the respective applications. In such cases, even though there may be free space elsewhere on the memory components 112A to 112N, a given application can only read/write data to/from the associated zone, such as by erasing data stored in the zone and writing new data to the zone. The memory sub-system controller 115 can further include host interface circuitry to communicate with the host system 120 via the physical host interface. The host interface circuitry can convert the I/O commands received from the host system 120 into command instructions to access the memory components 112A to 112N as well as convert responses associated with the memory components 112A to 112N into information for the host system 120.

The memory sub-system 110 can also include additional circuitry or components that are not illustrated. In some embodiments, the memory sub-system 110 can include a cache or buffer (e.g., DRAM or other temporary storage location or device) and address circuitry (e.g., a row decoder and a column decoder) that can receive an address from the memory sub-system controller 115 and decode the address to access the memory components 112A to 112N.

The memory devices can be raw memory devices (e.g., NAND), which are managed externally, for example, by an external controller (e.g., memory sub-system controller 115). The memory devices can be managed memory devices (e.g., managed NAND), which is a raw memory device combined with a local embedded controller (e.g., local media controllers) for memory management within the same memory device package. Any one of the memory components 112A to 112N can include a media controller (e.g., media controller 113A and media controller 113N) to manage the memory cells of the memory component, to communicate with the memory sub-system controller 115, and to execute memory requests (e.g., read or write) received from the memory sub-system controller 115.

In some embodiments, the memory sub-system controller 115 can include an error handling module 122. The error handling module 122 monitors operations of the memory sub-system 110. Based on the operations, the error handling module 122 can generate or receive critical event trigger data. The critical event trigger data is used to identify errors that correspond to one or more fatal conditions. Based on whether the errors in the critical event trigger data correspond to fatal or non-fatal conditions, the error handling module 122 performs an error handling mode that is selected from different types of error handling modes.

In some cases, the error handling module 122 can determine that the critical event trigger data corresponds to a non-fatal error. For example, the error handling module 122 can compare an error code associated with the critical event trigger data with a list of error codes associated with non-fatal errors. If the error code matches one of the error codes on the list of non-fatal error codes, the error handling module 122 determines that the error is non-fatal. For example, the error handling module 122 can compare an error code associated with the critical event trigger data with a list of error codes associated with fatal errors. If the error code fails to match one of the error codes on the list of fatal error codes, the error handling module 122 determines that the error is non-fatal. In such cases, the error handling module 122 can perform a first error handling mode to generate a partial snapshot (e.g., can store a first set of debugging information) representing the state of one or more specified components or modules of the memory sub-system 110. In such circumstances, the error handling module 122 generates and stores the snapshot without interrupting the host system 120. The error handling module 122 may notify the host system 120 instantly or at some later point that an error exists and that a snapshot has been stored but the error handling module 122 allows one or more I/O operations to continue to be performed by the memory sub-system 110.

In some cases, the error handling module 122 can determine that the critical event trigger data corresponds to a fatal error. For example, the error handling module 122 can compare an error code associated with the critical event trigger data with a list of error codes associated with fatal errors. If the error code matches one of the error codes on the list of fatal error codes, the error handling module 122 determines that the error is fatal. For example, the error handling module 122 can compare an error code associated with the critical event trigger data with a list of error codes associated with non-fatal errors. If the error code fails to match one of the error codes on the list of non-fatal error codes, the error handling module 122 determines that the error is fatal. In such cases, the error handling module 122 can perform a second error handling mode to generate a full snapshot (e.g., can store a second set of debugging information that includes the first set of debugging information) representing the state of all or substantially all of the components or modules of the memory sub-system 110. In such circumstances, the error handling module 122 generates and stores the snapshot and interrupts the host system 120 to indicate the error that is detected. The error handling module 122 may prevent subsequent I/O operations from being performed by the memory sub-system 110. As referred to herein, a “partial snapshot” represents a state of a subset of components that are represented by a “full snapshot.”

Depending on the embodiment, the error handling module 122 can comprise logic (e.g., a set of transitory or non-transitory machine instructions, such as firmware) or one or more components that causes the memory sub-system 110 (e.g., the memory sub-system controller 115) to perform operations described herein with respect to the error handling module 122. The error handling module 122 can comprise a tangible or non-tangible unit capable of performing operations described herein.

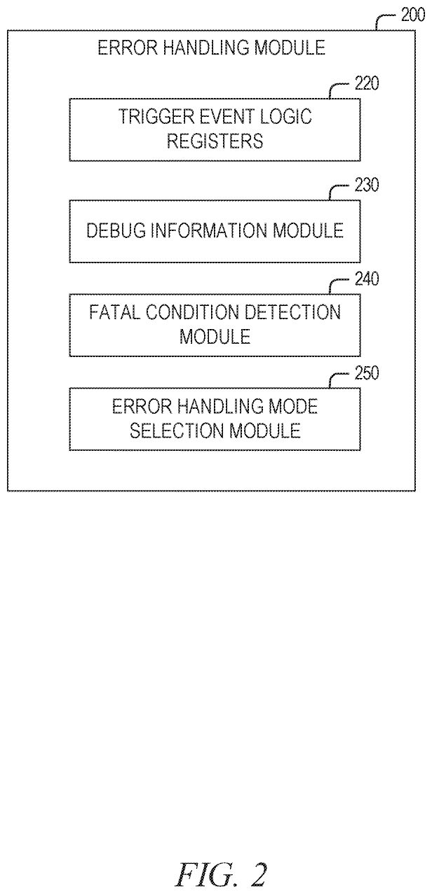

FIG. 2 is a block diagram of an example error handling module 200, in accordance with some implementations of the present disclosure. The error handling module 200 can represent the error handling module 122 of FIG. 1. As illustrated, the error handling module 200 includes trigger event logic registers 220, a debug information module 230, a fatal condition detection module 240, and/or an error handling mode selection module 250. The trigger event logic registers 220 store a list of error events that are monitored. For example, the trigger event logic registers 220 can be programmed or configured to monitor the state of certain registers, FIFO buffers, command queues, and other memory sub-system 110 components and modules. Based on a combination of states of the components and modules being monitored, the trigger event logic registers 220 can be configured to generate different critical event trigger data (e.g., different error codes). The critical event trigger data can include at least one of Non-Volatile Memory Express (NVMe) command timeout being triggered, Cyclic Redundancy Code (CRC) Errors exceeding a CRC threshold, PCIe AXI Error event, Uncorrectable Errors (UE) event, read or write completion latency exceeding a read or write threshold, reset event information, and/or memory parity errors exceeding a parity threshold

In some embodiments, the trigger event logic registers 220 communicate the critical event trigger data to the fatal condition detection module 240. The fatal condition detection module 240 searches a list of error codes to identify one or more error codes corresponding to the critical event trigger data. For example, the fatal condition detection module 240 can determine that the critical event trigger data matches an error code associated with non-fatal errors. In such cases, the fatal condition detection module 240 determines that the critical event trigger data corresponds to a non-fatal error condition. As another example, the fatal condition detection module 240 can determine that the critical event trigger data matches an error code associated with fatal errors. In such cases, the fatal condition detection module 240 determines that the critical event trigger data corresponds to a fatal error condition. The fatal condition detection module 240 communicates an indication of whether an error is fatal or non-fatal to the error handling mode selection module 250.

The error handling mode selection module 250 can select between a plurality of error handling modes to perform or execute based on the indication of whether the current error is fatal or non-fatal. For example, the error handling mode selection module 250 can select a first error handling mode in response to determining that the error is fatal. This first error handling mode can be referred to as a “panic” mode. In such cases, the error handling mode selection module 250 instructs the debug information module 230 to collect and capture a first set of debugging information corresponding to fatal errors. For example, the error handling mode selection module 250 instructs the debug information module 230 to capture a full snapshot when the error is determined to be fatal. In response to determining that the error is fatal, the error handling mode selection module 250 also generates an interrupt signal that is transmitted to the host indicating the fatal error. The error handling mode selection module 250 also instructs the memory sub-system 110 to stop executing further I/O commands and to only allow BFM commands to be executed. These BFM commands can be specialized commands that are received from the memory controller 115 and/or the host.

The error handling mode selection module 250 can perform a warm reset or restart of the memory sub-system 110 and can store the first set of debugging information selectively in a reserved portion of the memory components 112A to 112N. In some cases, the error handling mode selection module 250 can replace one or more previously stored sets of debugging information in the reserved portion with the first set of debugging information when any one or combination of certain conditions are met that indicate that the first set of debugging information is more valuable to retain than one of the previously stored set of debugging information.

In some embodiments, the error handling mode selection module 250 detects that a power cycle event has been performed with respect to the memory sub-system 110. In response, the error handling mode selection module 250 determines that the current error handling mode is the panic mode. In such cases, the error handling mode selection module 250 monitors for user input to selectively execute one or more BFM to perform debugging operations or to perform a normal reboot operation.

In some embodiments, the error handling mode selection module 250 can select a second error handling mode in response to determining that the error is non-fatal. This first error handling mode can be referred to as a “snapshot” mode. In such cases, the error handling mode selection module 250 instructs the debug information module 230 to collect and capture a second set of debugging information corresponding to non-fatal errors. For example, the error handling mode selection module 250 instructs the debug information module 230 to capture a partial snapshot when the error is determined to be non-fatal.

In such cases, the error handling mode selection module 250 can attempt to store the partial snapshot (e.g., the second set of debugging information) in a reserved portion of the set of memory components 112A to 112N. The error handling mode selection module 250 can initialize or initiate a timer that is set to a threshold period of time. The error handling mode selection module 250 can determine whether the partial snapshot is successfully saved or stored in the reserved portion of the set of memory components 112A to 112N before the timer reaches (counts up or counts down) to the threshold period of time. In response to determining that the partial snapshot has been successfully saved or stored before ethe timer reaches the threshold period of time, the error handling mode selection module 250 cancels the timer and resumes monitoring for future critical event trigger data. In response to determining that the partial snapshot has not been successfully (has failed to be successfully) saved or stored before the timer reaches the threshold period of time, the error handling mode selection module 250 performs operations corresponding to the panic mode. Namely, the error handling mode selection module 250 instructs the debug information module 230 to collect and capture the first set of debugging information (e.g., the full snapshot) corresponding to fatal errors. The error handling mode selection module 250 also generates an interrupt signal that is transmitted to the host. The error handling mode selection module 250 also instructs the memory sub-system 110 to stop executing further I/O commands and to only allow BFM commands to be executed. These BFM commands can be specialized commands that are received from the memory controller 115 and/or the host.

In some embodiments, the debug information module 230 can store instances of the full snapshots (captured at different points in time) in a first reserved portion of the set of memory components 112A to 112N. The debug information module 230 can store instances of the partial snapshots (captured at different points in time) in a second reserved portion of the set of memory components 112A to 112N. This way, partial snapshots (collected in the process of performing the second error handling mode) can be accessed and represent a state of the memory sub-system 110 separately from the full snapshots (collected in the process of performing the first error handling mode).

In some embodiments, the debug information module 230 can selectively displace or replace a previously stored instance of debug information (full snapshot and/or partial snapshot) when a new instance of debug information is received. Particularly, the debug information module 230 can determine that a new partial snapshot has been generated. In response, the debug information module 230 can determine whether the second reserved portion of the set of memory components 112A to 112N has sufficient capacity or storage space to fit the new instance of the partial snapshot. In response to determining that the second reserved portion fails to include sufficient capacity or storage space, the debug information module 230 analyzes or computes a value of one or more previously stored partial snapshots and a value of the new partial snapshot to determine whether the new partial snapshot is more valuable than the one or more previously stored partial snapshots. For example, the debug information module 230 can compute a first condition by accessing a power cycle count representing number of times the memory sub-system 110 has been power cycled since the one or more previously stored partial snapshots has been stored. If the power cycle transgresses a power cycle threshold value (e.g., five) or if the one or more partial snapshots are associated with a read indication representing that the partial snapshots have previously been read by the host, the debug information module 230 can determine that the first condition is met and replace the one or more partial snapshots with the new partial snapshot.

As another example, the debug information module 230 can compute a second condition by accessing a power ON time for the memory sub-system 110 indicating how long the memory sub-system 110 has been powered ON since the one or more previously stored partial snapshots have been stored. The debug information module 230 can also compute an average quantity of I/O command completion rate representing number of I/O commands that have been completed within a given period of time. If the power ON time transgresses or corresponds to a threshold period of time or range (e.g., between 60 seconds and 900 seconds) and if the average quantity of I/O command completion rate transgresses a threshold rate (e.g., 5k I/O commands per second), the debug information module 230 can determine that the second condition is met and replace the one or more partial snapshots with the new partial snapshot.

As another example, the debug information module 230 can compute a third condition by accessing a power ON time for the memory sub-system 110 indicating how long the memory sub-system 110 has been powered ON since the one or more previously stored partial snapshots have been stored. The debug information module 230 can also compute a quantity of I/O commands that have been completed since the one or more previously stored partial snapshots have been stored. If the power ON time transgresses or corresponds to a threshold period of time (e.g., 900 seconds) and if the quantity of I/O commands transgresses a threshold value (e.g., 5 million I/O commands), the debug information module 230 can determine that the third condition is met and replace the one or more partial snapshots with the new partial snapshot.

In some embodiments, the debug information module 230 determines that the first, second and third conditions fail to be satisfied or met or that only two of the three conditions have been met. In such cases, the debug information module 230 prevents replacing the one or more partial snapshots with the new partial snapshot. The debug information module 230 deletes or fails to store the new partial snapshot and retains the one or more previously stored partial snapshots in the second reserved portion of the set of memory components 112A to 112N. In some cases, the debug information module 230 prevents replacing the prior stored snapshots with the new snapshot when any of the conditions are met.

It should be understood that similar operations with respect to replacing or not replacing prior stored full snapshots with new full snapshots can also be performed.

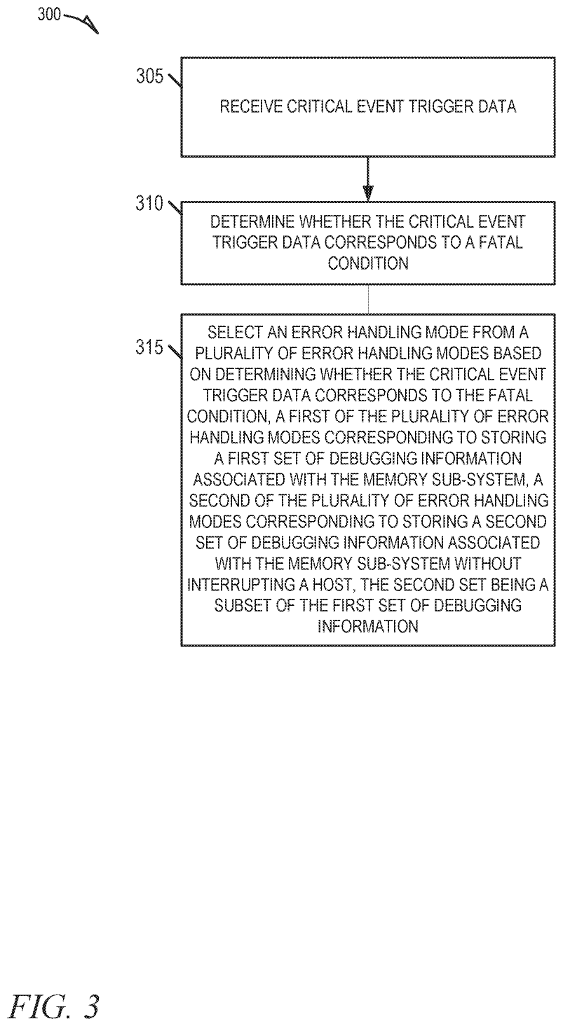

FIG. 3 is a flow diagram of an example method 300 to perform debug operations, in accordance with some implementations of the present disclosure. Method 300 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 300 is performed by the memory sub-system controller 115 or subcomponents of the controller 115 of FIG. 1. In these embodiments, the method 300 can be performed, at least in part, by the error handling module 200. Although the processes are shown in a particular sequence or order, unless otherwise specified, the order of the processes can be modified. Thus, the illustrated embodiments should be understood only as examples; the illustrated processes can be performed in a different order, and some processes can be performed in parallel. Additionally, one or more processes can be omitted in various embodiments. Thus, not all processes are required in every embodiment. Other process flows are possible.

Referring now FIG. 3, the method (or process) 300 begin at operation 305, with a error handling module 200 of a memory sub-system (e.g., of processor of the memory sub-system controller 115) receiving critical event trigger data. Then, at operation 310, the error handling module 200 determines whether the critical event trigger data corresponds to a fatal condition. The error handling module 200, at operation 315, selects an error handling mode form a plurality of error handling modes based on determining whether the critical event trigger data corresponds to the fatal condition. A first of the plurality of error handling modes can corresponds to storing a first set of debugging information associated with the memory sub-system and a second of the plurality of error handling modes can correspond to storing a second set of debugging information associated with the memory sub-system without interrupting a host. The second set can be a subset of the first set of debugging information.

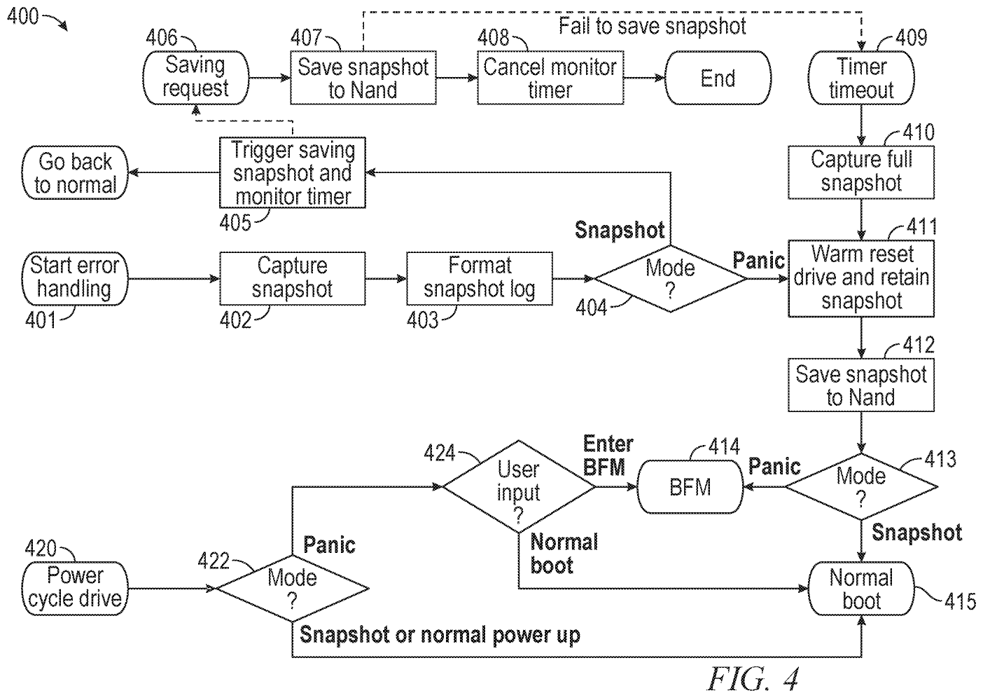

FIG. 4 is a flow diagram of an example method 400 to perform debug operations, in accordance with some implementations of the present disclosure. Method 400 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 400 is performed by the memory sub-system controller 115 or subcomponents of the controller 115 of FIG. 1. In these embodiments, the method 400 can be performed, at least in part, by the error handling module 200. Although the processes are shown in a particular sequence or order, unless otherwise specified, the order of the processes can be modified. Thus, the illustrated embodiments should be understood only as examples; the illustrated processes can be performed in a different order, and some processes can be performed in parallel. Additionally, one or more processes can be omitted in various embodiments. Thus, not all processes are required in every embodiment. Other process flows are possible.

Referring now FIG. 4, the method (or process) 400 begin at operation 401, with the error handling module 200 of a memory sub-system (e.g., of processor of the memory sub-system controller 115) starting an error handling operation (e.g., in response to receiving critical trigger event data). The error handling module 200, at operation 402, captures a snapshot (e.g., a full snapshot) and, at operation 403, the error handling module 200 formats the snapshot according to certain specified format for debugging. The error handling module 200, at operation 404, selects an error handling mode between a snapshot mode (in which a partial snapshot is stored) and a panic mode (in which a full snapshot is stored).

At operation 405, in response to selecting the snapshot mode, the error handling module 200 triggers saving the partial version of the captured snapshot and initializes a timer. The error handling module 200, at operation 406, generates a request to save the partial version of the captured snapshot in a correspond reserved portion of the set of memory components 112A to 112N. At operation 407, the set of memory components 112A to 112N attempt to save the partial version of the snapshot before the timer reaches a specified threshold value. Then, the error handling module 200, at operation 408, cancels the timer in response to determining that the partial version of the snapshot was successfully saved before the timer reaches a specified threshold value. The error handling module 200 determines, at operation 409, that the timer reached the threshold value before the partial version of the snapshot was successfully saved. In such cases, the error handling module 200 proceeds to operation 410 in which a full snapshot is captured and/or generated and a warm reset of the memory sub-system 110 is performed at operation 411 to retain the snapshot.

At operation 412, the error handling module 200 saves the full snapshot on the set of memory components 112A to 112N and, at operation 413, the error handling module 200 determines the error handling mode that was selected. In response to determining that the error handling mode corresponds to the panic mode, the error handling module 200 proceeds to operation 414 in which memory operations are restricted to BFM operations. In response to determining that the error handling mode corresponds to the snapshot mode, the error handling module 200 proceeds to operation 415 in which memory sub-system 110 is rebooted.

The error handling module 200, at operation 420, determines that a power cycle event was received, such as from the host. In response, the error handling module 200 determines the error handling mode that was selected at operation 422. In response to determining that the error handling mode corresponds to the panic mode, the error handling module 200 proceeds to operation 424 to monitor for user input corresponding to debugging operations (e.g., requesting BFM commands and/or requesting a normal reboot to be performed). In response to determining that the error handling mode corresponds to the snapshot mode at operation 422, the error handling module 200 proceeds to operation 415 in which memory sub-system 110 is rebooted.

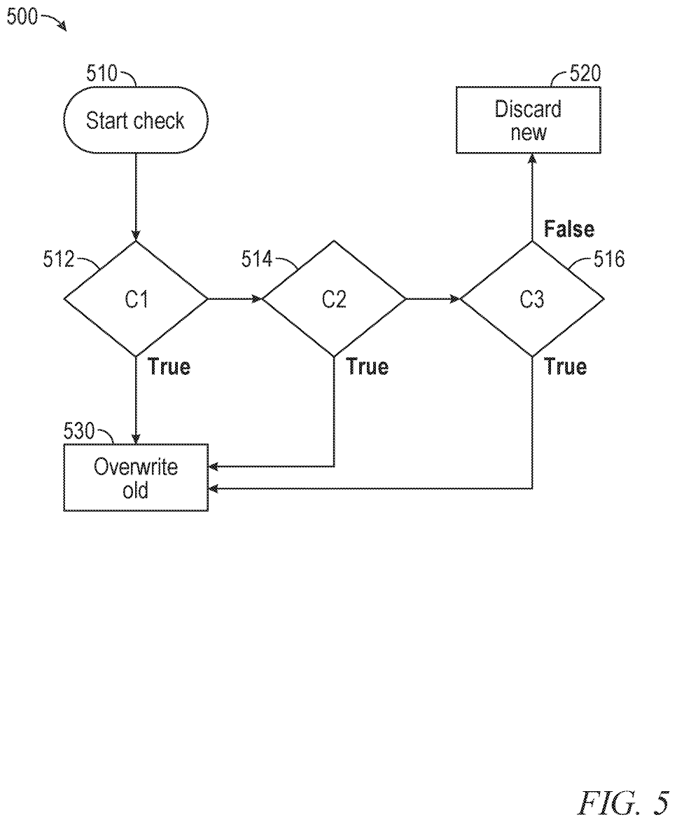

FIG. 5 is a flow diagram of an example method 500 to perform debug operations, in accordance with some implementations of the present disclosure. Method 500 can be performed by processing logic that can include hardware (e.g., a processing device, circuitry, dedicated logic, programmable logic, microcode, hardware of a device, an integrated circuit, etc.), software (e.g., instructions run or executed on a processing device), or a combination thereof. In some embodiments, the method 500 is performed by the memory sub-system controller 115 or subcomponents of the controller 115 of FIG. 1. In these embodiments, the method 500 can be performed, at least in part, by the error handling module 200. Although the processes are shown in a particular sequence or order, unless otherwise specified, the order of the processes can be modified. Thus, the illustrated embodiments should be understood only as examples; the illustrated processes can be performed in a different order, and some processes can be performed in parallel. Additionally, one or more processes can be omitted in various embodiments. Thus, not all processes are required in every embodiment. Other process flows are possible.

Referring now FIG. 5, the method (or process) 500 begin at operation 501, with the error handling module 200 of a memory sub-system (e.g., of processor of the memory sub-system controller 115) starting to check if sufficient capacity or space is available in a reserved portion of the set of memory components 112A to 112N for a new instance of a snapshot (full or partial) to be stored. If not, the error handling module 200 checks one or more conditions including a first condition 512, a second condition 514 and a third condition 516 with respect to prior stored instances of snapshots to determine whether the prior instances have more value than the new instance of the snapshot.

In some cases, the first condition corresponds to a power cycle count since the previous instance was stored. The second condition can correspond to a power ON time and an average quantity of I/O command completion rate. The third condition can correspond to the power ON time and a quantity of I/O commands executed or completed since the previous instance was stored.

At operation 530, a prior instance of the snapshot is replaced with the new instance of the snapshot in response to determining that one or more of the first, second and third conditions is satisfied. At operation 520, the new instance of the snapshot is discarded and deleted and the prior instance of the snapshot is retained and not replaced by the new instance of the snapshot.

In view of the disclosure above, various examples are set forth below. It should be noted that one or more features of an example, taken in isolation or combination, should be considered within the disclosure of this application.

Example 1: a system comprising: a memory sub-system comprising a set of memory components; and a processing device, operatively coupled to the set of memory components and configured to perform operations comprising: receiving critical event trigger data; determining whether the critical event trigger data corresponds to a fatal condition; and selecting an error handling mode from a plurality of error handling modes based on determining whether the critical event trigger data corresponds to the fatal condition, a first of the plurality of error handling modes corresponding to storing a first set of debugging information associated with the memory sub-system, and a second of the plurality of error handling modes corresponding to storing a second set of debugging information associated with the memory sub-system without interrupting a host, the second set being a subset of the first set of debugging information.

Example 2, the system of Example 1 wherein the first set of debugging information includes a state of the memory sub-system representing a status of at least one of one or more data structures, one or more queues, or one or more state machines.

Example 3, the system of Examples 1 or 2, wherein the critical event trigger data includes at least one of Non-Volatile Memory Express (NVMe) command timeout being triggered, Cyclic Redundancy Code (CRC) Errors exceeding a CRC threshold, PCIe AXI Error event, Uncorrectable Errors (UE) event, read or write completion latency exceeding a read or write threshold, reset event information, or memory parity errors exceeding a parity threshold.

Example 4, the system of any one of Examples 1-3, the operations comprising selecting the first of the plurality of error handling modes in response to determining that the critical event trigger data corresponds to the fatal condition; and transmitting an interrupt signal to the host to initiate debugging operations in response to selecting the first of the plurality of error handling modes.

Example 5, the system of any one of Examples 1-4, wherein the operations comprise: selecting the second of the plurality of error handling modes in response to determining that the critical event trigger data corresponds to a non-fatal condition.

Example 6, the system of Example 5, wherein the operations comprise: generating the second set of debugging information according to a specified format; and saving the second set of debugging information on the set of memory components.

Example 7, the system of Example 6, wherein the operations comprise: initializing a timer for saving the second set of debugging information; determining that the timer has reached a threshold value; and determining whether the second set of debugging information has successfully been saved on the set of memory components in response to determining that the timer has reached the threshold value.

Example 8, the system of Example 7, wherein the operations comprise: in response to determining that the second set of debugging information has failed to successfully be saved on the set of memory components after the timer has reached the threshold value, generating the first set of debugging information.

Example 9, the system of any one of Examples 1-8, wherein the operations comprise: resetting the memory sub-system; saving the first or second sets of debugging information on the set of memory components; andin response to determining that the first of the plurality of error handling modes has been selected, restricting a set of operations of the memory sub-system to operations performed in a basic function mode.

Example 10, the system of any one of Examples 1-9, wherein the operations comprise: reserving a first portion of the set of memory components for storing one or more instances of the first set of debugging information; and reserving a second portion of the set of memory components for storing one or more instances of the second set of debugging information.

Example 11, the system of any one of Examples 1-10, wherein the operations comprise: storing one or more instances of sets of debugging information in a reserved portion of the set of memory components; receiving a new instance of an individual set of debugging information corresponding to the selected error handling mode; and replacing a target instance of the one or more instances stored in the reserved portion of the set of memory components with the new instance of the individual set of debugging information.

Example 12, the system of Example 11, wherein the operations comprise: determining that a value associated with the target instance is lower than a value associated with the new instance, wherein the target instance is replaced in response to determining that the value associated with the target instance is lower than the value associated with the new instance.

Example 13, the system of Example 12, wherein determining that the value associated with the target instance is lower than the value associated with the new instance comprises: determining whether one or more conditions for replacing the target instance are met.

Example 14, the system of Example 13, wherein the one or more conditions include a power cycle count, a power on time, or a count associated with input/output commands.

Example 15, the system of any one of Examples 1-14, wherein the target instance is replaced in response to determining that a power cycle count, representing number of times the memory sub-system has been power cycled, transgresses a power cycle threshold value.

Example 16, the system of any one of Examples 1-15, wherein the operation comprise preventing replacing the target instance with the new instance in response to determining that a power cycle count, representing number of times the memory sub-system has been power cycled, fails to transgress a power cycle threshold value.

Example 17, the system of any one of Examples 1-16, wherein the target instance is replaced in response to determining that the memory sub-system has been powered on for more than a threshold time period and an average quantity of input/output command completion rate transgresses a threshold rate.

Example 18, the system of any one of Examples 1-17, wherein the target instance is replaced in response to determining that the memory sub-system has been powered on for more than a threshold time period and a quantity of input/output commands that have been completed since the target instance was stored transgresses a threshold value.

Methods and computer-readable storage medium with instructions for performing any one of the above Examples.

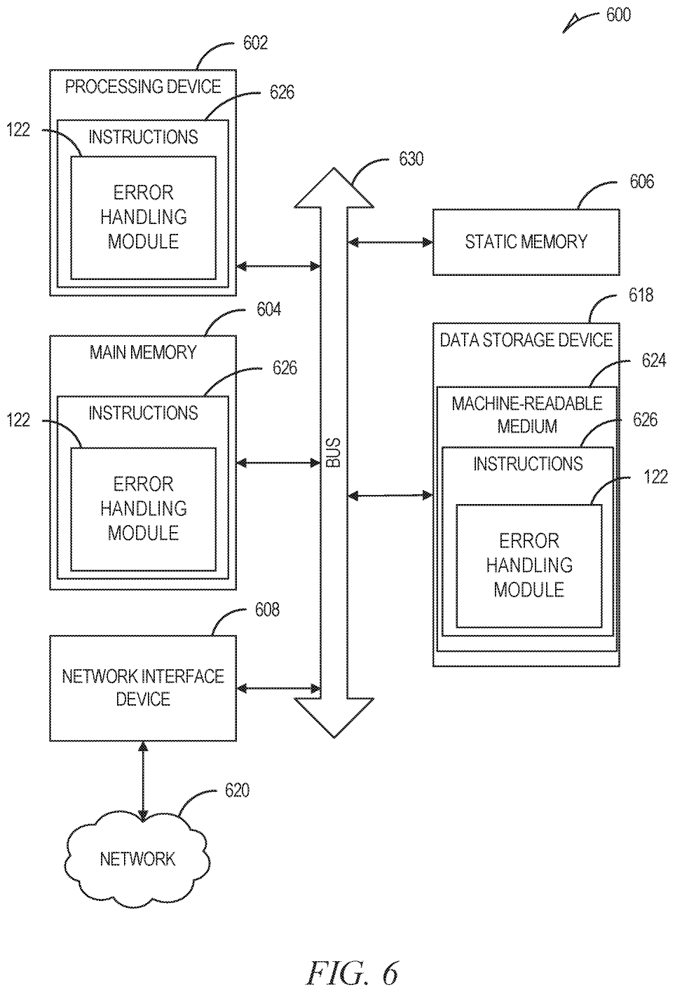

FIG. 6 illustrates an example machine in the form of a computer system 600 within which a set of instructions can be executed for causing the machine to perform any one or more of the methodologies discussed herein. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the error handling module 122 of FIG. 1). In alternative embodiments, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a network switch, a network bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

The processing device 602 represents one or more general-purpose processing devices such as a microprocessor, a central processing unit, or the like. More particularly, the processing device 602 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 602 can also be one or more special-purpose processing devices such as an application specific integrated circuit (ASIC), a field programmable gate array (FPGA), a digital signal processor (DSP), a network processor, or the like. The processing device 602 is configured to execute instructions 626 for performing the operations and steps discussed herein. The computer system 600 can further include a network interface device 608 to communicate over a network 620.

The data storage system 618 can include a machine-readable storage medium 624 (also known as a computer-readable medium) on which is stored one or more sets of instructions 626 or software embodying any one or more of the methodologies or functions described herein. The instructions 626 can also reside, completely or at least partially, within the main memory 604 and/or within the processing device 602 during execution thereof by the computer system 600, the main memory 604 and the processing device 602 also constituting machine-readable storage media. The machine-readable storage medium 624, data storage system 618, and/or main memory 604 can correspond to the memory sub-system 110 of FIG. 1.

In one embodiment, the instructions 626 include instructions to implement functionality corresponding to firmware slot manager (e.g., the error handling module 122 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system's memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks; read-only memories (ROMs); random access memories (RAMs); erasable programmable read-only memories (EPROMs); EEPROMs; magnetic or optical cards; or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description above. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine-readable (e.g., computer-readable) storage medium such as a read-only memory (ROM), random access memory (RAM), magnetic disk storage media, optical storage media, flash memory components, and so forth.

In the foregoing specification, embodiments of the disclosure have been described with reference to specific example embodiments thereof. It will be evident that various modifications can be made thereto without departing from the embodiments of the disclosure as set forth in the following claims. The specification and drawings are, accordingly, to be regarded in an illustrative sense rather than a restrictive sense.

What is claimed is:

1. A system comprising:
a memory sub-system comprising a set of memory components; and
a processing device, operatively coupled to the set of memory components and configured to perform operations comprising:
receiving critical event trigger data;
determining whether the critical event trigger data corresponds to a fatal condition; and
selecting an error handling mode from a plurality of error handling modes based on determining whether the critical event trigger data corresponds to the fatal condition, a first of the plurality of error handling modes corresponding to storing a first set of debugging information associated with the memory sub-system, and a second of the plurality of error handling modes corresponding to storing a second set of debugging information associated with the memory sub-system without interrupting a host, the second set being a subset of the first set of debugging information.

2. The system of claim 1, wherein the first set of debugging information includes a state of the memory sub-system representing a status of at least one of one or more data structures, one or more queues, or one or more state machines.

3. The system of claim 1, wherein the critical event trigger data includes at least one of Non-Volatile Memory Express (NVMe) command timeout being triggered, Cyclic Redundancy Code (CRC) Errors exceeding a CRC threshold, PCIe AXI Error event, Uncorrectable Errors (UE) event, read or write completion latency exceeding a read or write threshold, reset event information, or memory parity errors exceeding a parity threshold.

4. The system of claim 1, wherein the operations comprise:
selecting the first of the plurality of error handling modes in response to determining that the critical event trigger data corresponds to the fatal condition; and
transmitting an interrupt signal to the host to initiate debugging operations in response to selecting the first of the plurality of error handling modes.

5. The system of claim 1, wherein the operations comprise:
selecting the second of the plurality of error handling modes in response to determining that the critical event trigger data corresponds to a non-fatal condition.

6. The system of claim 5, wherein the operations comprise:
generating the second set of debugging information according to a specified format; and
saving the second set of debugging information on the set of memory components.

7. The system of claim 6, wherein the operations comprise:
initializing a timer for saving the second set of debugging information;
determining that the timer has reached a threshold value; and
determining whether the second set of debugging information has successfully been saved on the set of memory components in response to determining that the timer has reached the threshold value.

8. The system of claim 7, wherein the operations comprise:
in response to determining that the second set of debugging information has failed to successfully be saved on the set of memory components after the timer has reached the threshold value, generating the first set of debugging information.

9. The system of claim 1, wherein the operations comprise:
resetting the memory sub-system;
saving the first or second sets of debugging information on the set of memory components; and
in response to determining that the first of the plurality of error handling modes has been selected, restricting a set of operations of the memory sub-system to operations performed in a basic function mode.

10. The system of claim 1, wherein the operations comprise:
reserving a first portion of the set of memory components for storing one or more instances of the first set of debugging information; and
reserving a second portion of the set of memory components for storing one or more instances of the second set of debugging information.

11. The system of claim 1, wherein the operations comprise:
storing one or more instances of sets of debugging information in a reserved portion of the set of memory components;
receiving a new instance of an individual set of debugging information corresponding to the selected error handling mode; and
replacing a target instance of the one or more instances stored in the reserved portion of the set of memory components with the new instance of the individual set of debugging information.

12. The system of claim 11, wherein the operations comprise:
determining that a value associated with the target instance is lower than a value associated with the new instance, wherein the target instance is replaced in response to determining that the value associated with the target instance is lower than the value associated with the new instance.

13. The system of claim 12, wherein determining that the value associated with the target instance is lower than the value associated with the new instance comprises:
determining whether one or more conditions for replacing the target instance are met.

14. The system of claim 13, wherein the one or more conditions include a power cycle count, a power on time, or a count associated with input/output commands.

15. The system of claim 13, wherein the target instance is replaced in response to determining that a power cycle count, representing number of times the memory sub-system has been power cycled, transgresses a power cycle threshold value.

16. The system of claim 13, wherein the operation comprise preventing replacing the target instance with the new instance in response to determining that a power cycle count, representing number of times the memory sub-system has been power cycled, fails to transgress a power cycle threshold value.

17. The system of claim 13, wherein the target instance is replaced in response to determining that the memory sub-system has been powered on for more than a threshold time period and an average quantity of input/output command completion rate transgresses a threshold rate.

18. The system of claim 13, wherein the target instance is replaced in response to determining that the memory sub-system has been powered on for more than a threshold time period and a quantity of input/output commands that have been completed since the target instance was stored transgresses a threshold value.

19. A method comprising:
receiving critical event trigger data;
determining whether the critical event trigger data corresponds to a fatal condition; and
selecting an error handling mode from a plurality of error handling modes based on determining whether the critical event trigger data corresponds to the fatal condition, a first of the plurality of error handling modes corresponding to storing a first set of debugging information associated with a memory sub-system, and a second of the plurality of error handling modes corresponding to storing a second set of debugging information associated with the memory sub-system without interrupting a host, the second set being a subset of the first set of debugging information.

20. A non-transitory computer-readable storage medium comprising instructions that, when executed by a processing device, cause the processing device to perform operations comprising:
receiving critical event trigger data;
determining whether the critical event trigger data corresponds to a fatal condition; and
selecting an error handling mode from a plurality of error handling modes based on determining whether the critical event trigger data corresponds to the fatal condition, a first of the plurality of error handling modes corresponding to storing a first set of debugging information associated with a memory sub-system, and a second of the plurality of error handling modes corresponding to storing a second set of debugging information associated with the memory sub-system without interrupting a host, the second set being a subset of the first set of debugging information.
